(19) United States
(12) Patent Application Publication
(10) Pub. No.: US 2024/0412466 A1
(43) Pub. Date: Dec. 12, 2024

(54) MIXED REALITY MANUFACTURING VISUALIZATION USING SPARE PARTS

(71) Applicant: INTERNATIONAL BUSINESS MACHINES CORPORATION, ARMONK, NY (US)

(72) Inventors: Binoy Thomas, Kozhikode (IN); Sarbajit K. Rakshit, Kolkata (IN); Sudheesh S. Kairali, Kozhikode (IN)

(21) Appl. No.: 18/329,891

(22) Filed: Jun. 6, 2023

(51) Int. Cl. G06T 19/00; G06T 17/00; G06V 10/20

(52) U.S. Cl. CPC G06T 19/006; G06T 17/00; G06V 10/255

(57) ABSTRACT

According to one embodiment, a method, computer system, and computer program product for mixed reality is provided. The present invention may include identifying one or more available spare parts in a physical location; analyzing the one or more available spare parts; analyzing one or more bill of materials to identify one or more end products that may be manufactured using one or more combinations of the one or more available spare parts; performing digital twin simulation of the one or more identified end products that may be manufactured to determine required quality of the one or more identified end products; creating one or more digital models of the one or more identified end products that may be manufactured; and displaying the one or more digital models in a mixed reality simulated environment to depict physical space needed to store the one or more identified end products that may be manufactured.

### BACKGROUND

The present invention relates, generally, to the field of computing, and more particularly to mixed reality.

Mixed reality (MR) is a technology that uses software to overlay virtual information onto a virtual environment to provide a person with an authentic virtual experience. Mixed reality is built on the convergence of virtual reality (VR) and augmented reality (AR), which allows for a web of networked immersive experiences in a multiuser persistent platform. Currently, mixed reality can be used to demonstrate the assembling of an end product using parts. However, people may have different types and quantities of parts but not know an end product(s) to assemble with those parts. Therefore, in order for true optimization of mixed reality, a method and system by which mixed reality can be used to visualize end products that can be manufactured using different combinations of available spare parts, are needed. Thus, an improvement in mixed reality has the potential to benefit the manufacturing process by providing the ability to identify and assemble different end products, either completely or partially, based on available spare parts.

### SUMMARY

According to one embodiment, a method, computer system, and computer program product for identifying one or more available spare parts in a physical location; analyzing the one or more identified available spare parts; analyzing one or more bill of materials to identify one or more end products that may be manufactured using one or more combinations of the one or more identified available spare parts; performing digital twin simulation of the one or more identified end products that may be manufactured to determine required quality of the one or more identified end products; creating one or more digital models of the one or more identified end products that may be manufactured; and displaying the one or more digital models of the one or more identified end products that may be manufactured in a mixed reality simulated environment to depict physical space needed to store the one or more identified end products that may be manufactured.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary application invention environment according to at least one embodiment;

FIG. 3 is an operational flowchart illustrating a mixed reality spare part visualization manufacturing process according to at least one embodiment; and

FIG. 4 is a system diagram illustrating an exemplary program environment of an implementation of a mixed reality spare part visualization manufacturing process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

In a manufacturing location, such as a warehouse, there are likely spare parts, used for manufacturing various end products, present in different quantities and qualities. These spare parts may be leftovers from manufacturing different end products or just random inventory. Thus, the spare parts may not appear to have an obvious or defined use, and therefore, not be utilized in manufacturing an end product. Moreover, over time, the spare parts may likely build up in quantity. As a result, the spare parts will solely occupy valuable space in the manufacturing location until they are thrown away as waste.

Currently, existing methods attempt to both reduce waste during the manufacturing process and optimize the manufacturing process in various methods. One way in which current methods attempt to address problems with reducing waste during the manufacturing process and optimizing the manufacturing process, is by demonstrating the assembling of an end product using parts. However, scenarios exist where people may have different types and quantities of parts but not know an end product(s) to assemble with those parts. Other ways in which current methods attempt to address problems with reducing waste during the manufacturing process and optimizing the manufacturing process are functionally similar to the previously described method, in that they identify an end product and the spare parts needed to build the end product. It is important that, in addition to the current methods, a method exists to identify end products to manufacture based on available spare parts. Thus, an improvement in MR has the potential to benefit the manufacturing process by providing the ability to identify and assemble different end products, either completely or partially, based on available spare parts.

The present invention has the capacity to improve the field of manufacturing by utilizing mixed reality to visualize different end products that can be manufactured using different combinations of available spare parts. The present invention can identify different end products, either completely or partially, based on available spare parts in a physical environment, such as a manufacturing factory. This improvement in manufacturing can be accomplished by implementing a system that identifies available spare parts in a physical environment, based on performing object recognition using a mixed reality device and querying an inventory list in the database, analyzes the quality of the available spare part(s) using visual inspection and digital twin simulation, and analyzes one or more bill of materials to identify potential end product(s) to manufacture, either partially or completely, using a combination of the available spare parts. This improvement in manufacturing can further be accomplished by implementing a system that performs digital twin simulation of the potential manufactured end product(s) to determine if the required quality of the identified potential manufactured end product(s) may be met if manufactured using the available spare parts, creates a digital model(s) of the potential manufactured end product(s), and displays the digital model(s) of the potential manufactured end product(s) in a mixed reality simulated environment using a mixed reality device to depict the physical space needed to store the potential manufactured end product(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to identify one or more available spare parts in a physical location, analyze the one or more identified available spare parts, analyze one or more bill of materials to identify one or more end products that may be manufactured using one or more combinations of the one or more identified available spare parts, perform digital twin simulation of the one or more identified end products that may be manufactured to determine required quality of the one or more identified end products, create one or more digital models of the one or more identified end products that may be manufactured, and display the one or more digital models of the one or more identified end products that may be manufactured in a mixed reality simulated environment to depict physical space needed to store the one or more identified end products that may be manufactured.

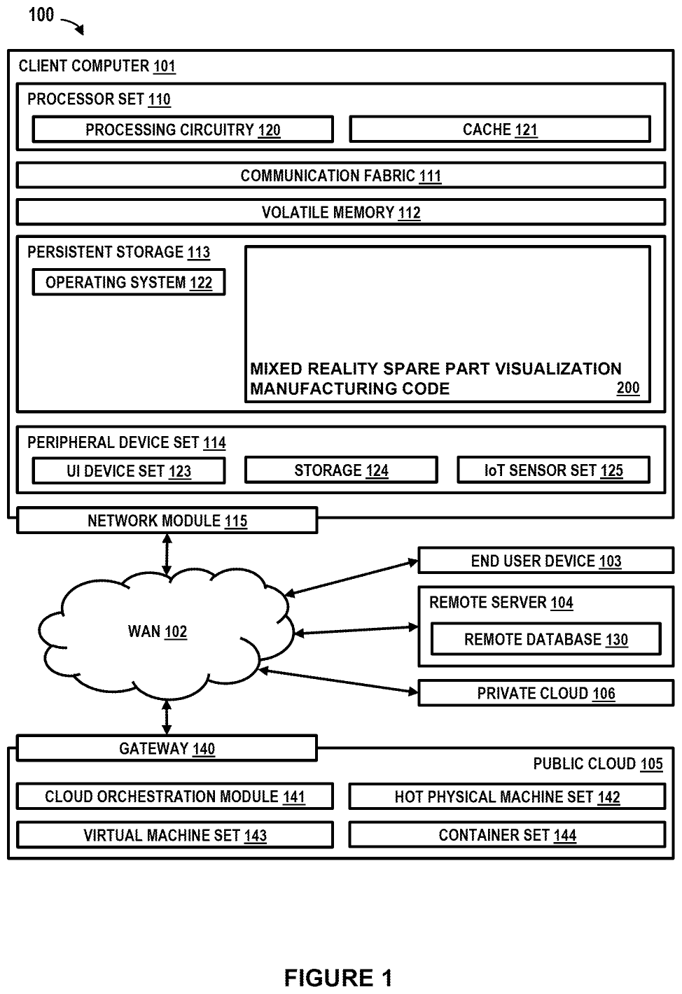

Beginning now with FIG. 1, an exemplary networked computer environment 100 is depicted, according to at least one embodiment. Computing environment 100 contains an example of an environment for the execution of at least some of the computer code involved in performing the inventive methods, such as mixed reality spare part visualization manufacturing code 200. In addition to code block 200 computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101.

Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

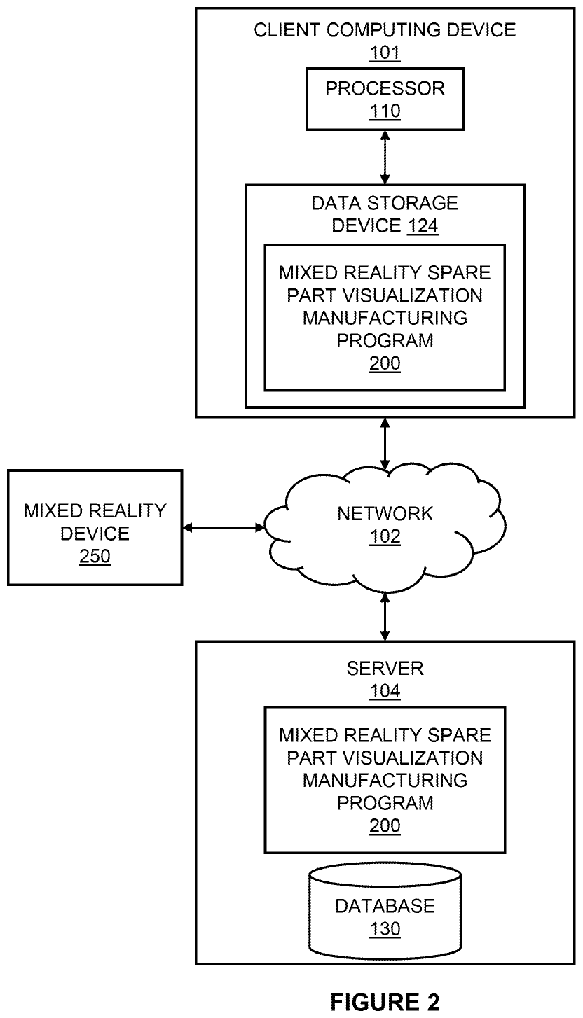

Referring to FIG. 2, an exemplary application environment is depicted, according to at least one embodiment. FIG. 2 may include client computing device 101 and a remote server 104 interconnected via a communication network 102. According to at least one implementation, FIG. 2 may include a plurality of client computing devices 101 and remote servers 104, of which only one of each is shown for illustrative brevity. It may be appreciated that FIG. 2 provides only an illustration of one implementation and does not imply any limitations with regard to the environments in which different embodiments may be implemented. Many modifications to the depicted environments may be made based on design and implementation requirements.

Client computing device 101 may include a processor 110 and a data storage device 124 that is enabled to host and run a mixed reality spare part visualization manufacturing program 200 and communicate with the remote server 104 via the communication network 102, in accordance with one embodiment of the invention.

The remote server computer 104 may be a laptop computer, netbook computer, personal computer (PC), a desktop computer, or any programmable electronic device or any network of programmable electronic devices capable of hosting and running a mixed reality spare part visualization manufacturing program 200 and a database 130 and communicating with the client computing device 101 via the communication network 102, in accordance with embodiments of the invention. The remote server 104 may also operate in a cloud computing service model, such as Software as a Service (SaaS), Platform as a Service (PaaS), or Infrastructure as a Service (IaaS). The remote server 104 may also be located in a cloud computing deployment model, such as a private cloud, community cloud, public cloud, or hybrid cloud.

The database 130 may be a digital repository capable of data storage and data retrieval. The database 130 can be present in the remote server 104 and/or any other location in the network 102. The database 130 can comprise an inventory of the available spare parts at a physical location, the type of available spare parts, and the physical features of the available spare parts, such as the size, dimensions, shape, and axis, of a spare part, the condition of a spare part, such as new, used, heavily used, etc. Also, the database 130 can comprise bill of materials for end products that can be manufactured. The bill of materials may comprise a manufactured end product, the size, and dimensions of the end product, a list of raw materials, sub-assemblies, intermediate assemblies, sub-components, parts, the quantities of each part/material/etc. needed to manufacture the specific end product, as well as the qualities of the manufactured end products usually attributed to the end product, such as its durability, flexibility, density, melting point, thermal conductivity, thermal expansion, corrosion resistance, hardness, etc. Additionally, the database 130 can comprise previously used spare parts, data relating to the previously used spare parts, such as the digital twin simulation data of the spare part, previously manufactured end products, and data relating to the manufactured end product(s), such as the dimensions of the end product, the quality of the end product, etc. Also, the database 130 may comprise information relating to object recognition, such as 3D digital models of spare parts. The database 130 may comprise digital twin models of spare parts and manufactured end products. The database 130 may comprise generated digital models of manufactured end products. The database 130 may update each time a new spare part is identified, used, and when a newly manufactured end product is created. Additionally, the database 130 may comprise information related to market research, market data, and product reviews.

Mixed reality (MR) device 250 may be any device or combination of devices, such as a headset, enabled to record world information that the MR module 402 may overlay with computer-generated perceptual elements to create an MR simulated environment. The MR device(s) 250 can record the actions, position, movements, etc. of an MR device 250 wearer, to track the MR device 250 wearer's movement within and interactions with the MR environment. The MR device 250 can display an MR simulated environment to an MR device 250 wearer and allow the MR device 250 wearer to interact with the MR environment. Also, the MR device 250 can comprise a head-mounted display (HMD). Additionally, the MR device 250 may be equipped with or comprise a number of sensors, such as a camera, microphone, and accelerometer, and these sensors may be equipped with or comprise a number of user interface devices such as touchscreens, speakers, etc.

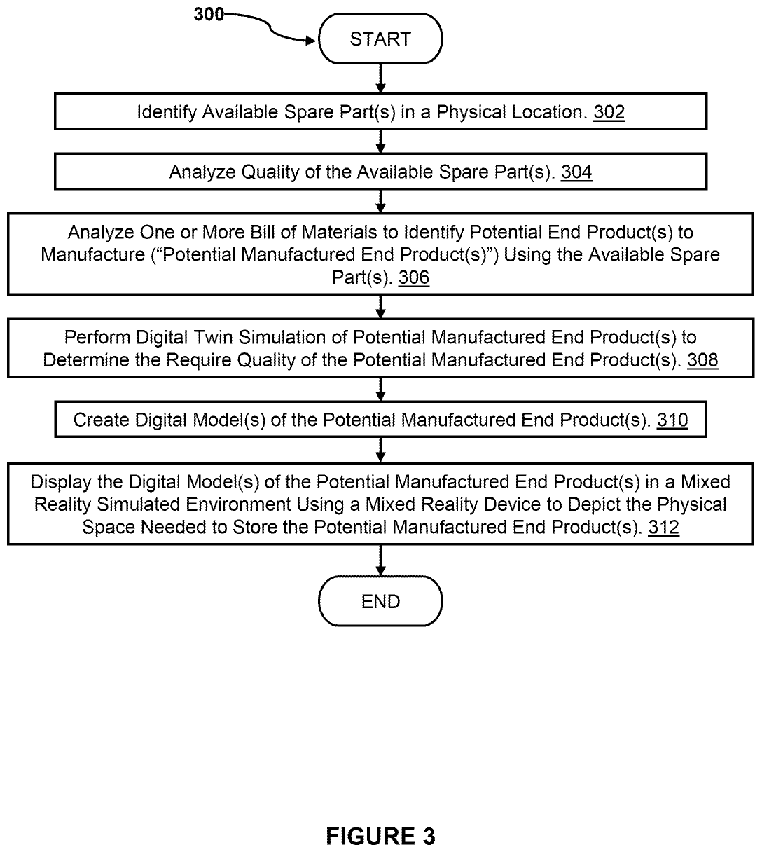

According to the present embodiment, the mixed reality spare part visualization manufacturing code 200, “the program”, may be a program capable of identifying available spare part(s) in a physical environment, based on performing object recognition using a mixed reality device and querying an inventory list in the database, analyzing the quality of the available spare part(s) using visual inspection and digital twin simulation, analyzing one or more bill of materials to identify potential end product(s) to manufacture, either partially or completely, using a combination of the available spare parts, performing digital twin simulation of the potential manufactured end product(s) to determine if the required quality of the identified potential manufactured end product(s) may be met if manufactured using the available spare parts, creating a digital model(s) of the potential manufactured end product(s), and displaying the digital model(s) of the potential manufactured end product(s) in a mixed reality simulated environment using a mixed reality device to depict the physical space needed to store the potential manufactured end product(s). The program 200 may be located on client computing device 101 or remote server 104 or on any other device located within network 102. Furthermore, the program 200 may be distributed in its operation over multiple devices, such as client computing device 101 and remote server 104. The mixed reality spare part visualization manufacturing method is explained in further detail below with respect to FIG. 3.

Referring now to FIG. 3, an operational flowchart illustrating a mixed reality spare part visualization manufacturing process 300 is depicted according to at least one embodiment. At 302, the program 200 identifies available spare part(s) for use in manufacturing a potential end product by using an MR device 250 to capture an MR device 250 wearer's, such as an engineer, real-world surroundings and by checking an inventory list of available spare parts comprised on the database 130. A spare part, for example, a spring, a gear, etc., may comprise raw materials, duplicate parts, extra parts, and other materials used to manufacture an apparatus. The program 200 can query the inventory list of available spare parts comprised on the database 130 to identify available spare parts based on what spare parts are listed as available. Additionally, the program 200 can detect and identify spare parts in an MR device 250 wearer's real-world surrounding environments using object recognition. The program 200 can perform object recognition using artificial intelligence systems such as IBM Watson® (IBM Watson® and all IBM Watson®-based trademarks and logos are trademarks or registered trademarks of International Business Machines Corporation, and/or its affiliates). Object recognition may comprise identifying physical objects in image data received from the MR device 250 wearer's surrounding environment. Additionally, object recognition may comprise comparing image data to 3D digital models of spare parts in the database 130 to determine the identification of a physical object within a certain statistical percentage of assurance. Specifically, the program 200 can ingest the image data from the MR device 250 through trained machine learning algorithms, such as convolutional neural networks (“CNNs”). The trained machine learning algorithms can recognize and classify spare parts in the physical environment, and can determine the physical features of a spare part, such as the size, dimensions, shape, and axis, of the spare part. The program 200 can train the machine learning algorithms using training data. Training data may comprise collected data on spare parts in a physical environment, such as the size, dimensions, shape, and axis, of a spare part.

At 304, the program 200 analyzes the quality of the available spare part(s) using visual inspection and digital twin simulation. The program 200 can perform visual inspection and digital twin simulation using artificial intelligence systems such as Maximo® Visual Inspection (Maximo® and all Maximo®-based trademarks and logos are trademarks or registered trademarks of International Business Machines Corporation, and/or its affiliates). The program 200 can ingest the data of the available spare parts and the physical features of the spare parts into the deep learning visual inspection models to determine the quality(-ies) of the spare parts, such as durability, flexibility, density, melting point, thermal conductivity, thermal expansion, corrosion resistance, hardness, etc., as well as the condition of the spare parts, such as new, used, heavily used, etc. Additionally, the program 200 can input the data of the available spare parts and the physical features of the spare parts into the digital twin to determine the quality(-ies) of the spare parts and the condition of the spare parts.

At 306, the program 200 analyzes one or more bill of materials to identify potential end product(s) to manufacture (“potential manufactured end product(s)”), either completely or partially, using a combination of the available spare parts. The program 200 can identify potential manufactured end product(s), for example, an alarm clock, a watch, a toy car, etc., based on the available inventory of the different types of spare parts, the quality(-ies) of the different types of spare parts, and the required quality of the manufactured end products. Specifically, the program 200 can determine potential end product(s) to manufacture by cross-validating the sizing, density, dimensions, solidity, and other physical attributes of the identified spare parts with the sizing, density, dimensions, solidity, and other physical attributes of an identified manufactured product. Additionally, the MR device 250 wearer may identify an end product(s) that the wearer is looking to manufacture and the required quality of the end product(s), through a drop-down menu on the GUI of the MR device 250. The program 200 can identify how the spare parts are to be assembled and the positions the spare parts would be placed in based on a bill of materials.

At 308, the program 200 performs digital twin simulation of the potential manufactured end product(s) to determine if the required quality of the identified potential manufactured end product(s) may be met if manufactured using the available spare parts. The program 200 can import the data of the potential manufactured end product(s) that can be manufactured using a combination of the available spare parts, from the one or more corresponding bill of materials, and the data of the available spare part(s) into the digital twin simulation to create a digital twin model of the potential manufactured end product(s). The required quality of a manufactured end product may comprise the needed levels of durability, flexibility, density, melting point, thermal conductivity, thermal expansion, corrosion resistance, hardness, and other physical qualities, of the manufactured end product. A digital twin simulation can be a virtual representation of an object or system and is updated from real-time data and may use simulations to help decision-making. Digital twin simulation may be performed using artificial intelligence systems such as Maximo® (Maximo® and all Maximo®-based trademarks and logos are trademarks or registered trademarks of International Business Machines Corporation, and/or its affiliates). The digital twin simulation may simulate the quality levels of a potential manufactured end product using different combinations of the available spare parts to determine if the potential manufactured end product can be successfully manufactured using a particular combination of available spare parts. In some embodiments of the invention, the program 200 may modify the shape and/or dimensions of a manufactured end product based on the sizes and shapes of the combination of spare parts used to assemble the manufactured end product.

The program 200 can simulate different combinations of the available spare parts to maximize the price value of the manufactured end product. The program 200 may integrate with outside platforms, through WAN 102, to connect to outside platforms and analyze market research data, market trends, cost of products and spare parts, and other information related to customer preferences and profitability of a manufactured end product. Additionally, the program 200 may simulate different combinations of the available spare parts to maximize the number of manufactured end products that can be manufactured in general, or specifically, such as maximizing the number of manufactured end products that can be manufactured meeting a certain quality threshold.

In some embodiments of the invention, the program 200 can determine multiple types of potential end products that can be manufactured using different combinations of the available spare parts. For example, there may be “m” types of available spare parts identified, and one or more of the spare parts may be used for manufacturing different types of end products. The program 200 can simulate the manufacturing of multiple types of end products using combinations of the identified spare parts, and list the possible combinations, in a manner such as:

$$( {mC}_{1} + {mC}_{2} + {mC}_{3} + … + {mC}_{x} )$$

At 310, the program 200 creates digital model(s) of the potential manufactured end product(s) based on the dimensions and shape of the identified potential manufactured end product(s), accounting for any modifications based on the available spare parts that are going to be used, from the corresponding bill of materials. The program 200 can create a digital model of a potential manufactured end product for each potential manufactured end product that the program 200 determined can both be manufactured, either completely or partially, using a combination of the available spare parts and meet the required quality of the manufactured end product based on the results of the digital twin simulation. The program 200 may create a digital model of a potential manufactured end product using the mixed reality module 402. A digital model may comprise a 3D virtual representation of an identified potential manufactured end product. Additionally, the digital model(s) of the potential manufactured end product(s) can comprise data relating to the quality of the manufactured end product, such as the end product(s) costs, as well as physical attributes/qualities/features of the end product.

At 312, the program 200 displays the digital model(s) of the potential manufactured end product(s) in an MR simulated environment to depict the amount of physical space needed to store the potential manufactured end product(s). The program 200 may feed the data representing the digital model(s) of the potential manufactured end product(s) to the MR device 250. The program 200 can render the digital model of an identified manufactured end product in a mixed reality simulated environment using the mixed reality device 250. Also, the program 200 can render the quality information of the potential manufactured end product, such as the associated cost value of the end product as well as the physical attributes/qualities of the end product, in text form onto the mixed reality simulated environment. The program 200 can render a mixed reality (MR) simulated environment. The MR simulated environment may be a hybrid environment comprising both physical and virtual elements. The MR environment may comprise a hybrid physical/virtual world in which one or more MR device 250 wearers may enter, see, move around in, interact with, etc. through the medium of an MR device. The MR device 250 wearers in the MR environment may be able to see and/or interact with the same virtual objects and virtual elements, and may interact with virtual representations of each other. The MR environment may comprise MR environments wherein generated images, sounds, haptic feedback, and other sensations are integrated into a real-world environment. Additionally, the MR environment may comprise virtual reality (VR) environments that fully replace the physical environment with virtual elements, such that an MR device 250 wearer experiencing a VR environment cannot see any objects or elements of the physical world; however, the VR environments are anchored to real-world locations, such that the movement of the MR device 250 wearers, virtual objects, virtual environmental effects and elements all occur relative to the corresponding locations in the physical environment. In some embodiments of the invention, the program 200 may analyze the floor of the surrounding environment and display the potential manufactured end product(s) that fit in the analyzed physical space. Additionally, the MR device 250 wearer may select manufactured end product(s) to display from a list on the GUI of the MR device 250. Also, the program 200 can capture an MR device 250 wearer's hand movements using the MR device 250. While wearing the MR device 250, the MR device 250 wearer may point to a physical location in the surrounding area and the program 200 may dynamically display the digital model of the potential manufactured end product overlaid onto the corresponding physical location in the mixed reality simulated environment.

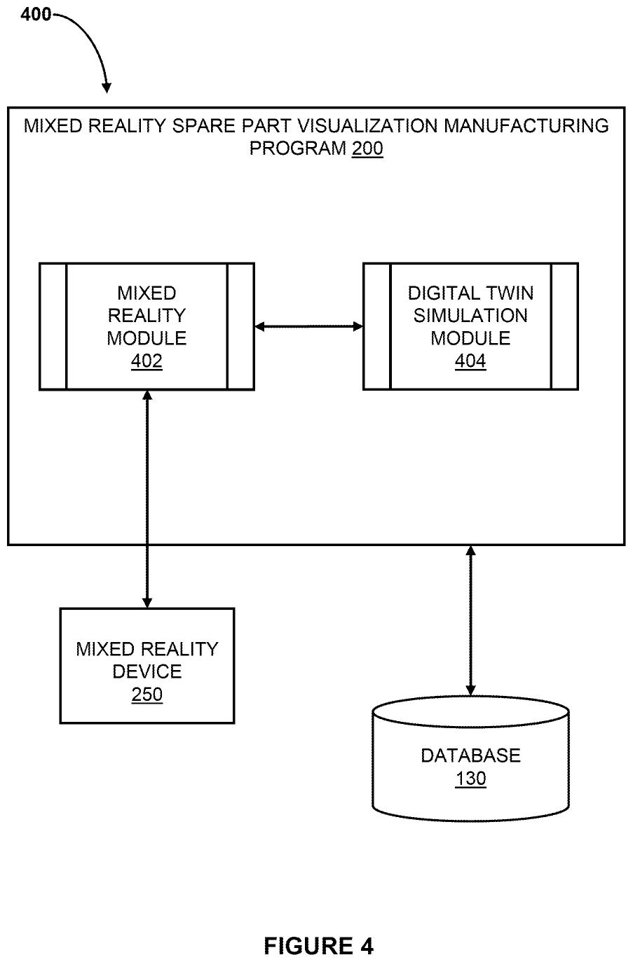

Referring now to FIG. 4, a system diagram illustrating an exemplary program environment 400 of an implementation of a mixed reality spare part visualization manufacturing process 300 is depicted according to at least one embodiment. Here, the program 200 comprises a mixed reality module 402 and a digital twin simulation module 404. The exemplary program environment 400 details the interactions between the mixed reality module 402 and the digital twin simulation module 404. Additionally, the exemplary program environment 400 details the interactions between the MR module 402 and the MR device 250, and the mixed reality spare part visualization manufacturing program 200 and the database 130.

The MR module 402 may be used to create and display an MR simulated environment and digital objects onto the MR simulated environment. The digital twin simulation module 404 may be used to perform digital twin simulation.

It may be appreciated that FIGS. 2 through 4 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for mixed reality, the method comprising:
identifying one or more available spare parts in a physical location;
analyzing the one or more identified available spare parts;
analyzing one or more bill of materials to identify one or more end products that may be manufactured using one or more combinations of the one or more identified available spare parts;
performing digital twin simulation of the one or more identified end products that may be manufactured to determine required quality of the one or more identified end products;
creating one or more digital models of the one or more identified end products that may be manufactured; and
displaying the one or more digital models of the one or more identified end products that may be manufactured in a mixed reality simulated environment to depict physical space needed to store the one or more identified end products that may be manufactured.

2. The method of claim 1, wherein the identifying of the one or more available spare parts may comprise querying an inventory list within a database and/or performing object recognition using a mixed reality device.

3. The method of claim 1, wherein the displaying of the one or more digital models of the one or more identified end products that may be manufactured in the mixed reality simulated environment comprises using a mixed reality device.

4. The method of claim 1, wherein the performing of the digital twin simulation of the one or more identified end products that may be manufactured to determine the required quality of the one or more identified end products may comprise simulating the one or more identified end products that may be manufactured using the one or more combinations of the one or more identified available spare parts.

5. The method of claim 1, wherein the one or more end products that may be manufactured using the one or more combinations of the one or more identified available spare parts, may comprise being manufactured completely or partially.

6. The method of claim 1, further comprising:
displaying quality-level information of the one or more identified end products that may be manufactured in text form in the mixed reality simulated environment.

7. The method of claim 1, wherein the analyzing of the one or more identified available spare parts comprises using visual inspection and/or the digital twin simulation.

8. A computer system for mixed reality, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying one or more available spare parts in a physical location;
analyzing the one or more identified available spare parts;
analyzing one or more bill of materials to identify one or more end products that may be manufactured using one or more combinations of the one or more identified available spare parts;
performing digital twin simulation of the one or more identified end products that may be manufactured to determine required quality of the one or more identified end products;
creating one or more digital models of the one or more identified end products that may be manufactured; and
displaying the one or more digital models of the one or more identified end products that may be manufactured in a mixed reality simulated environment to depict physical space needed to store the one or more identified end products that may be manufactured.

9. The computer system of claim 8, wherein the identifying of the one or more available spare parts may comprise querying an inventory list within a database and/or performing object recognition using a mixed reality device.

10. The computer system of claim 8, wherein the displaying of the one or more digital models of the one or more identified end products that may be manufactured in the mixed reality simulated environment comprises using a mixed reality device.

11. The computer system of claim 8, wherein the performing of the digital twin simulation of the one or more identified end products that may be manufactured to determine the required quality of the one or more identified end products may comprise simulating the one or more identified end products that may be manufactured using the one or more combinations of the one or more identified available spare parts.

12. The computer system of claim 8, wherein the one or more end products that may be manufactured using the one or more combinations of the one or more identified available spare parts, may comprise being manufactured completely or partially.

13. The computer system of claim 8, further comprising:
displaying quality-level information of the one or more identified end products that may be manufactured in text form in the mixed reality simulated environment.

14. The computer system of claim 8, wherein the analyzing of the one or more identified available spare parts comprises using visual inspection and/or the digital twin simulation.

15. A computer program product for mixed reality, the computer program product comprising:
one or more computer-readable tangible storage medium and program instructions stored on at least one of the one or more tangible storage medium, the program instructions executable by a processor to cause the processor to perform a method comprising:
identifying one or more available spare parts in a physical location;
analyzing the one or more identified available spare parts;
analyzing one or more bill of materials to identify one or more end products that may be manufactured using one or more combinations of the one or more identified available spare parts;
performing digital twin simulation of the one or more identified end products that may be manufactured to determine required quality of the one or more identified end products;
creating one or more digital models of the one or more identified end products that may be manufactured; and
displaying the one or more digital models of the one or more identified end products that may be manufactured in a mixed reality simulated environment to depict physical space needed to store the one or more identified end products that may be manufactured.

16. The computer program product of claim 15, wherein the identifying of the one or more available spare parts may comprise querying an inventory list within a database and/or performing object recognition using a mixed reality device.

17. The computer program product of claim 15, wherein the displaying of the one or more digital models of the one or more identified end products that may be manufactured in the mixed reality simulated environment comprises using a mixed reality device.

18. The computer program product of claim 15, wherein the performing of the digital twin simulation of the one or more identified end products that may be manufactured to determine the required quality of the one or more identified end products may comprise simulating the one or more identified end products that may be manufactured using the one or more combinations of the one or more identified available spare parts.

19. The computer program product of claim 15, wherein the one or more end products that may be manufactured using the one or more combinations of the one or more identified available spare parts, may comprise being manufactured completely or partially.

20. The computer program product of claim 15, further comprising:
displaying quality-level information of the one or more identified end products that may be manufactured in text form in the mixed reality simulated environment.
